(19) United States
(12) Patent Application Publication
(10) Pub. No.: US 2017/0159360 A1
(43) Pub. Date: Jun. 8, 2017

(54) TOP DRIVE QUILL WITH REMOVABLE FLANGE

(71) Applicant: Cameron International Corporation, Houston, TX (US)

(72) Inventors: Michael R. Netecke, Houston, TX (US); Richard O. Bradley, Houston, TX (US)

(21) Appl. No.: 14/956,753

(22) Filed: Dec. 2, 2015

(51) Int. Cl. E21B 3/02; H02K 7/14

(52) U.S. Cl. CPC E21B 3/02; H02K 7/14

(57) ABSTRACT

A top drive system with a removable flange is provided. In one embodiment, a top drive includes a quill, a motor coupled to drive rotation of the quill, and a swivel including a housing and a bearing disposed within the housing. The top drive also includes a removable flange attached to the quill within the housing of the swivel. The bearing and the removable flange are positioned within the housing such that the bearing bears weight of the quill via the removable flange. Additional systems, devices, and methods are also disclosed.

### BACKGROUND

This section is intended to introduce the reader to various aspects of art that may be related to various aspects of the presently described embodiments. This discussion is believed to be helpful in providing the reader with background information to facilitate a better understanding of the various aspects of the present embodiments. Accordingly, it should be understood that these statements are to be read in this light, and not as admissions of prior art.

In order to meet consumer and industrial demand for natural resources, companies often invest significant amounts of time and money in finding and extracting oil, natural gas, and other subterranean resources from the earth. Particularly, once a desired subterranean resource such as oil or natural gas is discovered, drilling and production systems are often employed to access and extract the resource. These systems may be located onshore or offshore depending on the location of a desired resource.

Whether onshore or offshore, a drilling rig can be provided to drill a well to access the desired resource. A drill string can be suspended from the drilling rig and rotated to drill the well. While the drill string can be suspended from a kelly and driven by a rotary table on the drill floor of the drilling rig, in some instances the drill string is instead suspended from and driven by a top drive of the drilling rig. Such a top drive generally includes a quill (also referred to as a main shaft or drive stem) that can be connected to the drill string. The quill provides axial support to the drill string, while a motor in the top drive is connected to the quill to drive rotation of the drill string via the quill. The top drive can be raised and lowered via a hoisting system to raise and lower the drill string within the well.

### SUMMARY

Certain aspects of some embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present disclosure generally relate to a top drive with a quill having a removable flange. More specifically, at least certain top drive embodiments of the present disclosure include a quill with such a removable flange, as well as a main bearing. The main bearing absorbs axial loading of the quill via the removable flange, while the ability to remove the flange from the quill facilitates access to and replacement of the main bearing. The removable flange may take various forms, such as that of a split ring or a threaded flange having a grooved interior surface that mates with a grooved exterior surface of the quill.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of some embodiments without limitation to the claimed subject matter.

### BRIEF DESCRIPTION OF THE DRAWINGS

These and other features, aspects, and advantages of certain embodiments will become better understood when the following detailed description is read with reference to the accompanying drawings in which like characters represent like parts throughout the drawings, wherein:

FIG. 1 generally depicts a drilling system having a top drive in accordance with an embodiment of the present disclosure;

FIG. 2 is a block diagram of various components of a top drive in accordance with one embodiment;

FIG. 3 is a section view of a quill with a removable flange positioned on a main bearing in a swivel of a top drive in accordance with one embodiment;

FIGS. 4 and 5 are partially sectioned and fully sectioned exploded views of the quill, removable flange, and swivel depicted in FIG. 3;

FIG. 6 is a detail section view of the removable flange of FIGS. 3-5 on the main bearing within the swivel;

FIG. 7 is a sectioned exploded view similar to FIG. 5, but with the removable flange provided as a threaded flange in accordance with one embodiment; and

FIG. 8 is a detail section view of the threaded flange of FIG. 7 attached to the quill above the main bearing within the swivel.

### DETAILED DESCRIPTION OF SPECIFIC EMBODIMENTS

Specific embodiments of the present disclosure are described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements. Moreover, any use of “top,” “bottom,” “above,” “below,” other directional terms, and variations of these terms is made for convenience, but does not require any particular orientation of the components.

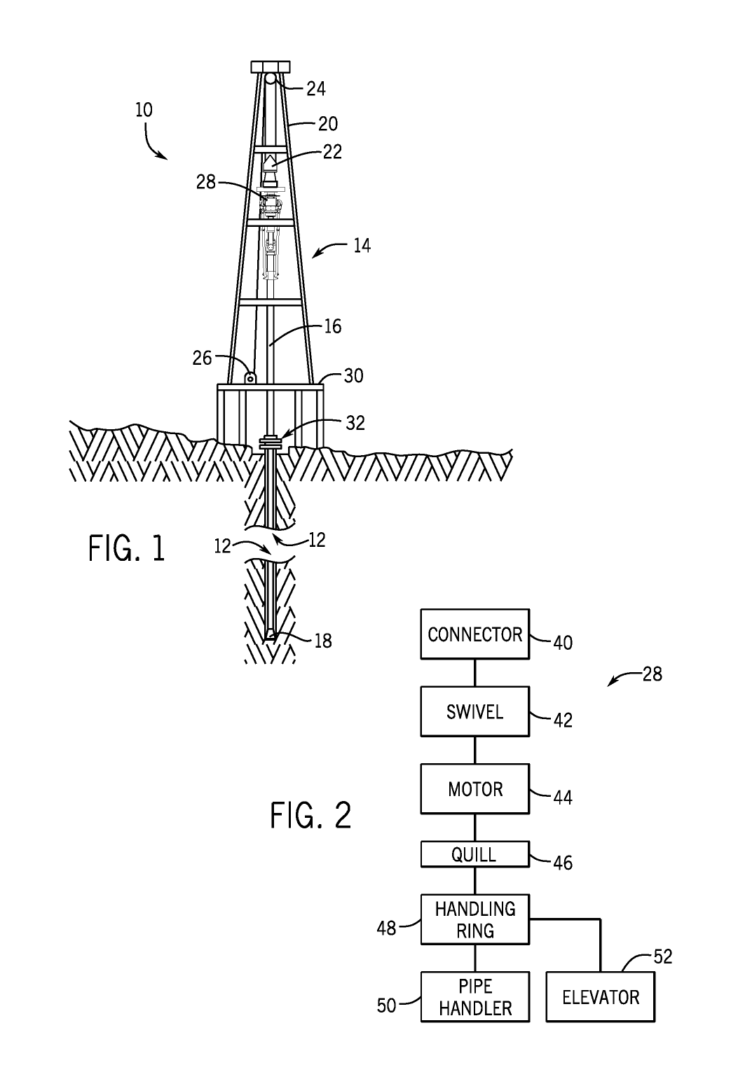

Turning now to the present figures, a drilling system 10 is illustrated in FIG. 1 in accordance with one embodiment. Notably, the system 10 may be operated to drill a well 12 to access a subterranean resource, such as oil or natural gas. As depicted, the system 10 includes an onshore drilling rig 14, although the system 10 could instead be an offshore system in other embodiments. The drilling rig 14 uses a drill string 16 and a drill bit 18 to form the well 12. It will be appreciated that the drill string 16 can include various members, such as drill pipes, tool joints, drill collars, and a saver sub that prevents wear on a threaded connection of a rotating system (e.g., a top drive) that drives rotation of the drill string 16.

The drilling rig 14 also includes a hoisting system (here generally shown as including a mast or derrick 20, a traveling block 22, a crown block 24, and drawworks 26) to enable a top drive 28 to be raised and lowered with respect to a drill floor 30. The drill string 16 (or some other tubular) is suspended from the top drive 28 through a hole in the drill floor 30 and through surface equipment (e.g., a blowout preventer 32 in the cellar). The drill string 16 can be rotated by the top drive 28 and can be raised and lowered with the top drive 28 (via the traveling block 22) to facilitate drilling operations.

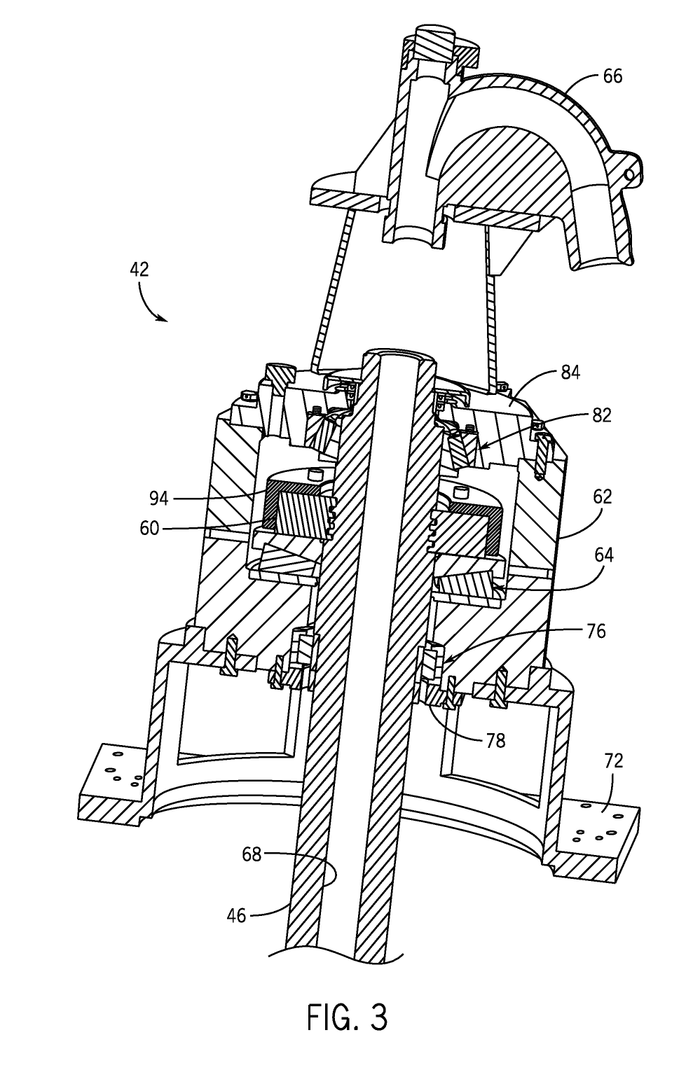

One example of a top drive 28 is generally depicted in FIG. 2. In this embodiment, the top drive 28 includes a connector 40 for attaching the top drive 28 to the traveling block 22. A quill 46 is suspended from a swivel 42 through a motor 44, which drives rotation of the quill 46 within the top drive 28. The motor 44 drives rotation of the quill 46 through a gearbox in some embodiments, though the motor 44 could drive the quill 46 directly without a gearbox in other instances. The quill 46 (which is sometimes referred to as a main shaft or a drive stem) extends downwardly through other components of the top drive 28 and can be connected to a drill string 16 (e.g., with a saver sub) to cause the drill string 16 to rotate along with the quill 46.

The top drive 28 of FIG. 2 also includes a handling ring 48 connected to a pipe handler 50 and to an elevator 52. In some embodiments, the pipe handler 50 is connected to the bottom of a main body of the handling ring 48, and the elevator 52 is connected to the handling ring 48 via links. The links can include linear actuators (e.g., hydraulic cylinders) to enable raising and lowering of the elevator 52 with respect to the pipe handler 50. In operation, the elevator 52 can grip a drill pipe (or a stand of drill pipes) and raise the drill pipe into the pipe handler 50. This drill pipe may then be rotated by the pipe handler 50 to connect the drill pipe to the quill 46. In some embodiments, connecting the drill pipe to the quill 46 includes threading the drill pipe onto an intermediate component (e.g., a saver sub) connected to the quill 46. This can be done to reduce wear on the threaded end of the quill 46, although the drill pipe could be connected directly to the quill 46 in other embodiments. Once connected to the quill 46, the drill pipe can be added to the drill string 16 by lowering the drill pipe and threading it into the rest of the drill string 16. And in other instances, the elevator 52 can grip the top of the drill string 16 to allow the elevator to raise or lower the drill string (e.g., into engagement with the quill 46 or a saver sub connected to the quill).

A quill is axially supported in a top drive by a main bearing, which can be located within the swivel or a gearbox, for example. The main bearing bears weight of the quill and any connected drill string, while still permitting rotation of the quill and the drill string. Given the weight carried by the main bearing, particularly with longer and heavier drill strings coupled to the quill, the main bearing can be exposed to considerable stresses that can be difficult to predict, which can lead to unexpected failure of the main bearing. In some previous designs, replacing a failed main bearing would entail replacing the top drive completely or rigging down the top drive from its mast or derrick so as to be able to disassemble the top drive and replace the failed bearing. In either case, failed main bearings would often cause significant (and costly) nonproductive time for equipment operators, drilling contractors, and oil companies.

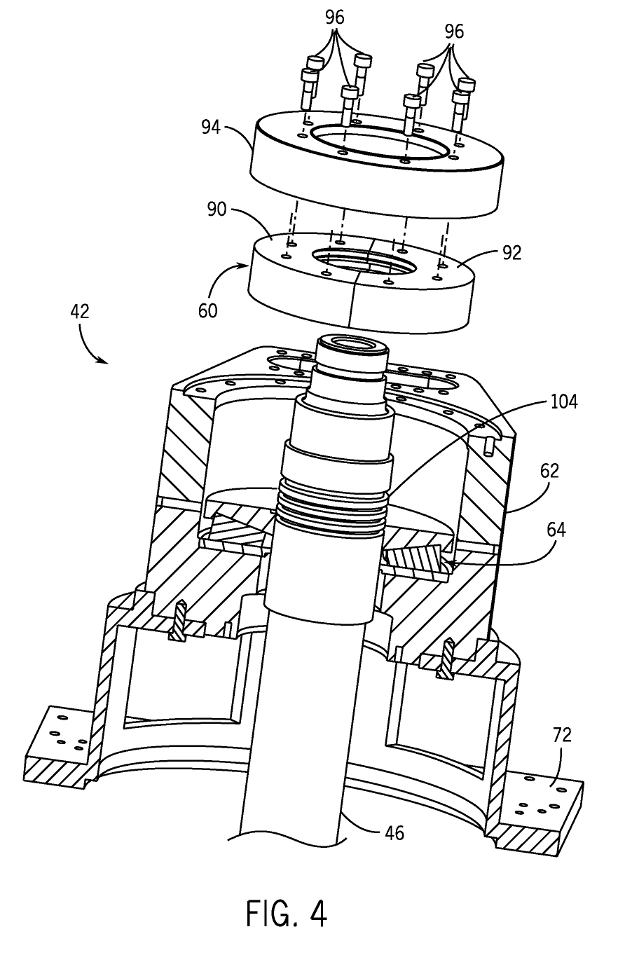

In contrast to such designs, however, at least some embodiments of the present disclosure include top drives having main bearings that can be replaced in the field while remaining connected to their hoisting systems (i.e., without rigging down the top drive). By way of example, a top drive swivel with such a field-replaceable main bearing is generally shown in FIGS. 3-6. In this depicted embodiment, the top drive includes a removable flange 60 coupled to the quill 46 within a body or housing 62 of the swivel 42. A main bearing 64 is also disposed within the housing 62 below the removable flange 60. The main bearing 64 is depicted as a tapered-roller thrust bearing, although the bearing 64 could be provided in other forms in different embodiments.

Fluid (e.g., drilling mud) can be pumped into the top drive through a gooseneck 66 of the swivel 42 and pass through a bore 68 of the quill 46 to the drill string 16. The depicted swivel includes a lower frame 72 for connecting the swivel 42 to other components of the top drive 28. Further, though not shown in FIG. 3, it will be appreciated that the swivel 42 can be connected to the hoisting system of the drilling rig 10, such as by a bail connected to the housing 62 and to a hook of the traveling block 22.

The top drive 28 can include other bearings to facilitate rotation of the quill 46. For example, as shown in FIG. 3, the swivel 42 includes a lower bearing 76 retained in the housing 62 by a lower plate 78, as well as an upper bearing 82 within the housing 62. These bearings 76 and 82 facilitate rotation of the quill 46 within the swivel 42. An upper plate 84 retains the bearing 82 within the housing 62, and removal of the upper plate 84 allows access to an interior cavity of the housing 62 having the main bearing 64 and the removable flange 60, as discussed further below.

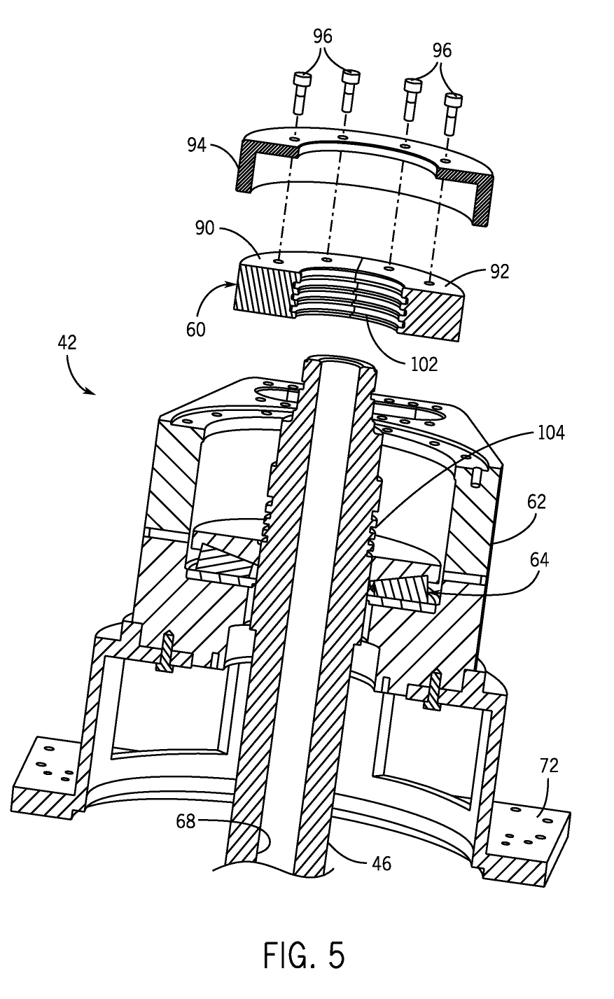

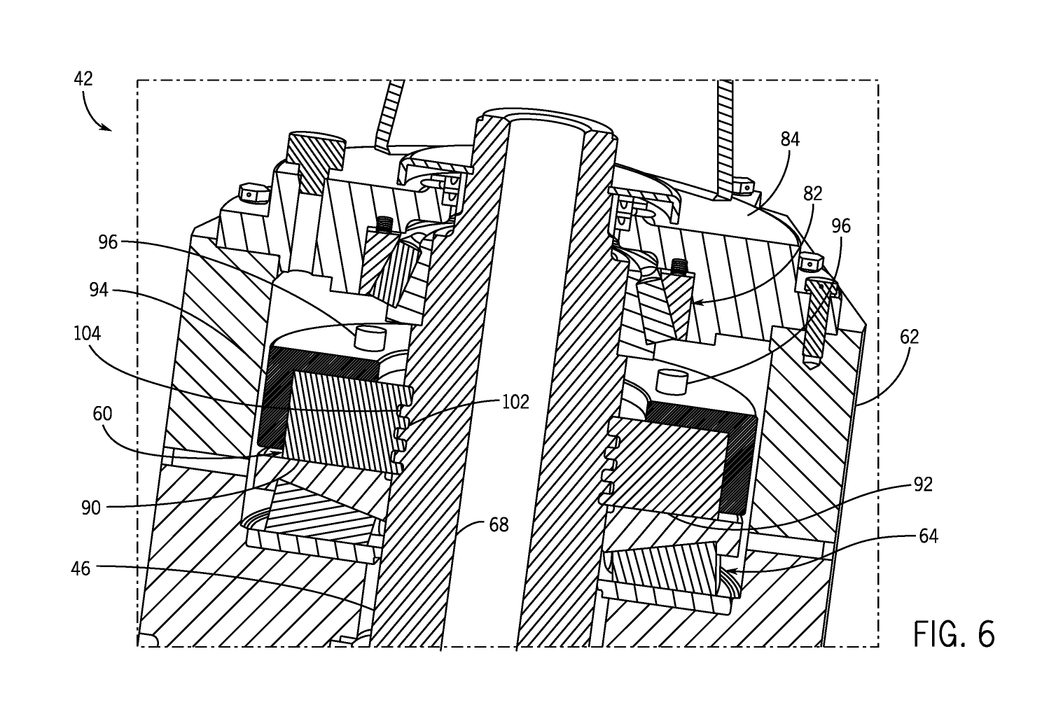

The removable flange 60 can be provided in various forms. For example, in FIGS. 4 and 5 the removable flange 60 is depicted as a split ring having ring segments 90 and 92. In this embodiment, the split ring is divided into two equal segments 90 and 92 to facilitate connection of the split ring to the quill 46, though a greater number of split ring segments could be used in other instances. Once the ring segments of the removable flange 60 are positioned about the quill 46, a collar 94 can be lowered over the ring segments to retain them in engagement with the quill 46, as depicted in FIG. 6.

The collar 94 can be attached to the ring segments of the removable flange 60 in any suitable manner. In the presently illustrated embodiment, fasteners 96 (e.g., bolts or cap screws) extend through holes in the collar 94 and into mating holes of the removable flange 60 so as to attach the collar 94 to the removable flange 60. In at least some embodiments, the collar 94 is also or instead joined to the flange 60 with an interference fit. Further, in some such instances, the collar 94 can be shrink-fitted to the removable flange 60 by heating the collar 94 to cause it to expand, placing the collar 94 about the split ring segments, and then allowing the collar to cool and thermally contract about the split ring.

In various embodiments, the removable flange and the quill have mating grooved surfaces to facilitate connection of the flange to the quill and allow weight of the quill (and another object, such as a drill string, attached to the bottom of the quill) to be borne by the main bearing 64 via the removable flange. As best shown in FIGS. 5 and 6, the removable flange 60 and the quill 46 include mating grooved surfaces 102 and 104. In this embodiment, each of the grooved surfaces 102 and 104 have multiple, concentric ridges (or “fingers”), and these ridges interlock with one another to allow the quill 46 to load against the removable flange 60 via the ridges. The removable flange 60 loads against the main bearing 64, which axially supports the quill 46 and any connected components (e.g., drill string 16, or some other tubular, connected with or without a saver sub).

Rather than rigging down the top drive 28 from the mast or derrick 20, the main bearing 64 in at least some of the presently disclosed embodiments can be removed in situ while the top drive 28 remains connected to the mast or derrick 20. In at least some instances, slips (e.g., at the drill floor 30) can be set to support the weight of the drill string 16 and connected quill 46. In one embodiment, a method for removing the main bearing 64 without disconnecting the top drive 28 from the mast or derrick 20 includes unfastening the upper plate 84 from the swivel body 62, and then removing the plate 84 and the bearing 82. This provides access to the collar 94. The method can further include disconnecting and removing the collar 94 from the removable flange 60, and then moving the split ring segments 90 and 92 radially outward to disconnect these segments from the quill 46. Like the bearing 82, the collar 94 and the removable flange 60 can be lifted out of the top of the body 62. Further, removal of the flange 60 from the quill 46 facilitates access to the main bearing 64 itself, which can also be lifted out of the top of the swivel body 62.

A main bearing 64 (whether the original main bearing or a replacement main bearing) and the removable flange 60 can be installed in the swivel body 62, and the other components can be assembled in reverse order from that described above, without disconnecting the top drive 28 from the mast or derrick 20. That is, in at least one embodiment the main bearing 64 is installed in the swivel body 62 (or in a gearbox or some other component of the top drive), the removable flange 60 is attached to the quill 46 (e.g., with the collar 94 to maintain engagement in the case of a split ring flange), the bearing 82 is positioned about the quill 46, and the upper plate 84 is attached to the swivel body 62, while the top drive 28 remains connected to the mast or derrick 20. The removable flange 60 can be positioned with respect to the main bearing such that the quill 46 applies an axial load to the main bearing 64 via the removable flange (e.g., upon raising of the top drive swivel 42 by the hoisting system or release of slips supporting the weight of a drill string connected to the quill 46).

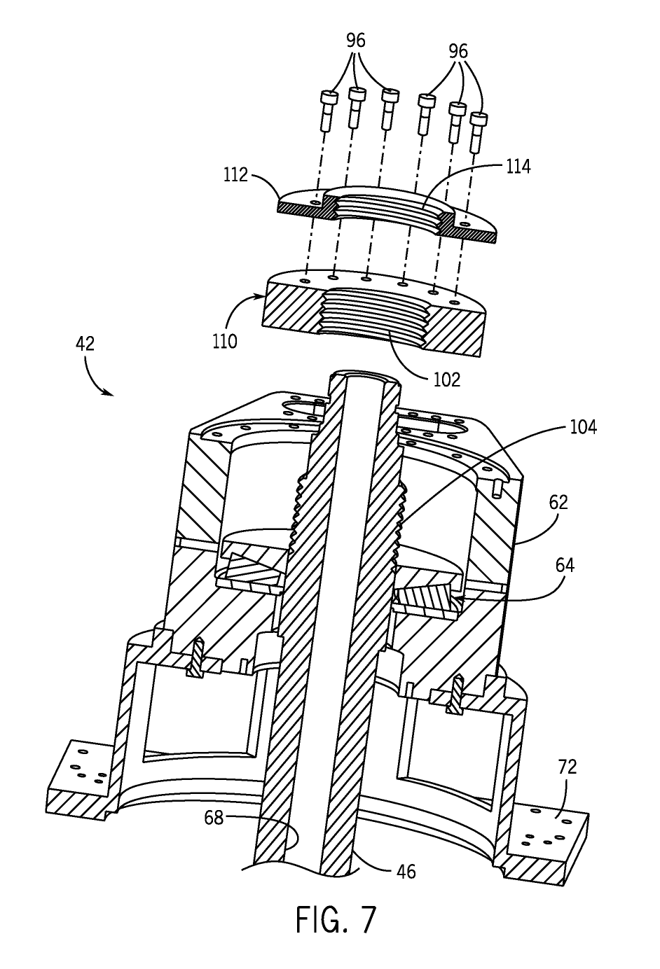

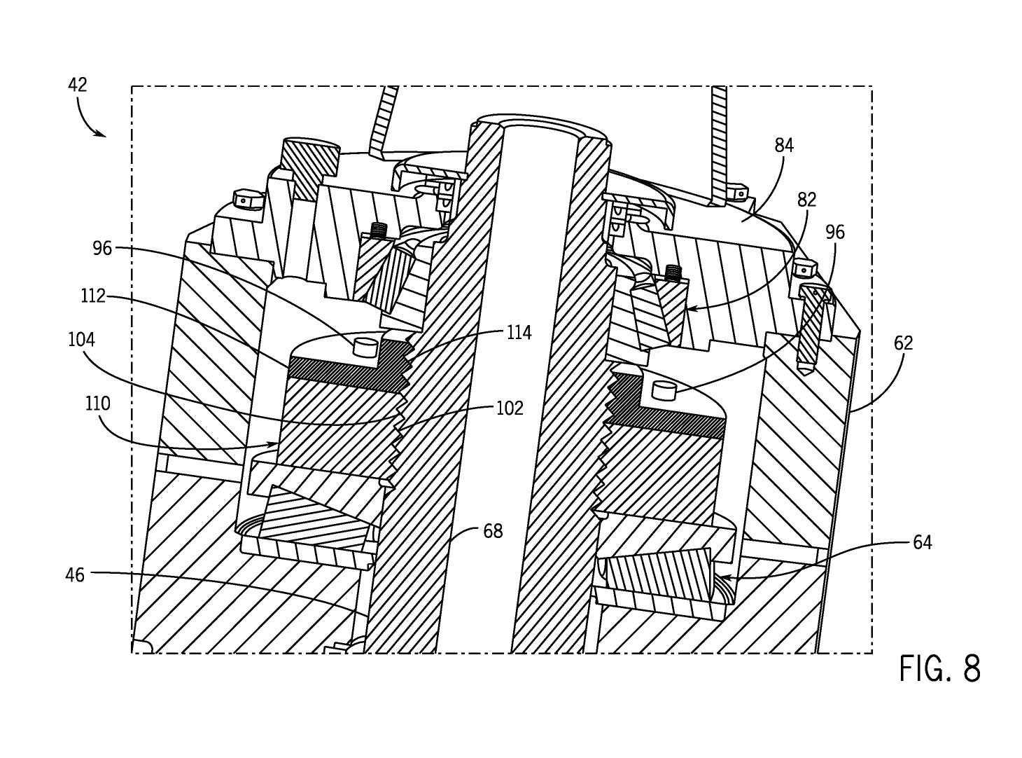

Although depicted as a split ring in FIGS. 3-6, the removable flange of the quill 46 supported by the main bearing 64 can be provided in other suitable forms. For example, the removable flange can instead be provided as a threaded flange 110 (e.g., a single-piece ring), as shown in FIGS. 7 and 8. In this depicted embodiment, the threaded flange 110 and the quill 46 have mating grooved surfaces 102 and 104 like those described above. But instead of these grooved surfaces having interlocking concentric ridges, the grooved surfaces 102 and 104 in FIGS. 7 and 8 are threaded surfaces so as to allow the flange 110 to be threaded onto the quill 46. As discussed further below, a retaining plate 112 having a threaded interior surface 114 can also be threaded onto the quill 46 above the threaded flange 110 through mating engagement with the quill surface 104. The threads of these surfaces 102, 104, and 114 can have any suitable profile; these surfaces can have buttress threads, trapezoidal threads, or square threads, for example, and the threaded surfaces could have single-start threads or multi-start threads. Further, the threads can be designed or modified for greater strength and durability. For instance, the threads (or portions thereof) can be shot-peened or include undercut roots.

As generally depicted in FIG. 8, the threaded flange 110 and the retaining plate 112 are both threaded onto the mating quill surface 104, with the quill 46 extending through these components. Further, the retaining plate 112 is shown attached to the threaded flange 110 with fasteners 96. In at least some embodiments using such a threaded flange 110, the installation and removal of the main bearing 64 is generally similar to that described above with respect to the split ring flange, but the flange 110 is threaded onto and off of the quill 46 (rather than having pieces 90 and 92 that are moved radially away from the quill to disengage the grooved surface 104) and the retaining plate 112 is threaded onto and off of the quill 46 and fastened to the flange 110 (rather than having the collar 94 fastened to the pieces 90 and 92).

The retaining plate 112 can be used to inhibit axial movement of the threaded flange 110 along the quill 46 once installed. In one embodiment, the threaded flange 110 and the retaining plate 112 are formed such that the fastening holes in these components for fasteners 96 do not align with one another when the threaded flange 110 and the retaining plate 112 are threaded onto the surface 104 and in abutment. In such cases, the retaining plate 112 can be backed off slightly from the flange 110 to align the holes and provide a small amount of separation between these two components along the quill 46. The fasteners 96 can be tightened to draw the components toward one another, causing the threaded surfaces 102 and 114 to apply a clamping force against the threaded surface 104.

In contrast to a quill having an integral flange (which may also be referred to as an integral head) for loading against a main bearing, the ability to remove the flange (or head) 60 of the quill 46 allows the quill to also be removed from the top drive from the bottom side of the swivel body 62, rather than only the top. This two-way removal option presents an opportunity for improvements in the ease of quill replacement, such as in the event of a rotary shoulder connection or load ring groove—thread failure. More specifically, rather than lowering the swivel 42 down along the quill 46, the swivel 42 can be lifted off of the quill 46, such as by using the swivel bail or whatever other form the component that transmits the primary load from the swivel body bail pins to the traveling block becket takes. It is noted that in some arrangements a traveling block will not have a becket (e.g., in the case of a split block, one or more adapter links may replace the swivel bail). Additionally, the ability to remove the flange 60 may also increase the ease with which the quill 46 could be replaced by lowering the swivel 42 onto the quill 46, rather than vice versa.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims.

1. A system comprising:
a top drive including:
a quill;
a motor coupled to drive rotation of the quill;
a swivel including a housing and a bearing disposed within the housing; and
a removable flange attached to the quill within the housing of the swivel, wherein the bearing and the removable flange are positioned within the housing such that the bearing bears weight of the quill via the removable flange.

2. The method of claim 1, wherein the removable flange and the quill are coupled together via mating grooved surfaces of the removable flange and the quill.

3. The system of claim 2, wherein the removable flange is a threaded flange and the mating grooved surfaces of the removable flange and the quill are mating threaded surfaces of the threaded flange and the quill.

4. The system of claim 3, comprising a retaining plate having a threaded interior surface configured to mate with the threaded surface of the quill.

5. The system of claim 4, wherein the retaining plate is threaded onto the quill above the threaded flange.

6. The system of claim 5, wherein the retaining plate is fastened to the threaded flange.

7. The system of claim 1, wherein the removable flange includes a split ring.

8. The system of claim 7, wherein the split ring has multiple split ring segments that engage the quill.

9. The system of claim 7, comprising a collar coupled to the split ring so as to maintain engagement of the split ring with the quill.

10. The system of claim 1, comprising a drilling rig including the top drive.

11. The system of claim 1, wherein the removable flange and the bearing are configured to allow rotation of the quill and a drill string coupled to the quill while the bearing bears weight of the quill and the drill string via the removable flange.

12. The system of claim 11, comprising the drill string coupled to the quill.

13. A system comprising:
a top drive with a field-replaceable main bearing, the top drive including a quill received through the main bearing and configured to drive rotation of a connected tubular, wherein the quill includes a flange positioned above the main bearing to enable the main bearing to axially support the quill and the connected tubular through the flange, and wherein the flange is a removable flange that can be separated from the quill to permit in situ removal of the main bearing from the top drive without disconnecting the top drive from a mast or derrick to which the top drive is connected.

14. The system of claim 13, wherein the removable flange and the main bearing are positioned within a swivel of the top drive.

15. The system of claim 13, wherein the removable flange includes a threaded flange or a split ring.

16. The system of claim 13, wherein the top drive is connected to the mast or derrick.

17. A method comprising:
installing a main bearing within a top drive;
attaching a removable flange to a quill of the top drive; and
positioning the removable flange with respect to the main bearing such that the quill applies an axial load to the main bearing via the removable flange.

18. The method of claim 17, wherein attaching the removable flange to the quill includes attaching a split ring to the quill or threading the removable flange onto the quill.

19. The method of claim 17, wherein the top drive is connected to a mast or derrick, and installing the main bearing within the top drive and attaching the removable flange to the quill are performed without disconnecting the top drive from the mast or derrick.

20. The method of claim 17, wherein installing the main bearing within the top drive includes installing the main bearing within a gearbox or a swivel of the top drive.

21. The method of claim 17, comprising lowering the top drive onto the quill such that the quill enters the top drive through a lower end of the top drive.
